(19) United States
(12) Patent Application Publication
(10) Pub. No.: US 2009/0091113 A1
(43) Pub. Date: Apr. 9, 2009

(54) EXTENDABLE BUS CROSSING ARM

(75) Inventors: James C. Bradley, New Haven, IN (US); Rodney J. Klinger, Fort Wayne, IN (US); Joseph T. Penaloza, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 11/867,758

(22) Filed: Oct. 5, 2007

(51) Int. Cl. B60R 21/34

(52) U.S. Cl. 280/762

(57) ABSTRACT

A crossing arm for a vehicle having a longitudinal axis includes a plurality of hollow telescoping members. The telescoping members are mounted onto the vehicle and configured for extension parallel to the longitudinal axis. The members define a variable volume chamber, where the chamber has a minimum volume when the members are nested, and the chamber has a maximum volume when the members are extended. An actuator is in fluid communication with the plurality of telescoping members and is configured for delivering fluid to the chamber to move at least one telescoping member with respect to a second telescoping member to extend the crossing arm.

### BACKGROUND OF THE INVENTION

The present invention relates generally to an automatic barrier, and more particularly, relates to an automatic, extendable barrier that is mounted on a vehicle.

Buses often have a crossing arm that extends out from the front of the bus generally parallel to the longitudinal axis of the bus. The crossing arm is typically automatically deployed by the driver when the bus is temporarily stopped to pick up or let off passengers, particularly children. The crossing arm is intended to prevent passengers from walking immediately in front of the vehicle. When the crossing arm is deployed, passengers tend to walk around the barrier, a distance away from the front of the bus, where the driver can see them.

The conventional crossing arms are typically actuated by a motor to pivot the arm from a first position, generally parallel to a front bumper of the bus, to a second position, generally parallel to the longitudinal axis of the bus. However, the linkage between the motor and the arm has a relatively high failure rate due to the typical loadings associated with a cantilevered system, including loadings imposed by the arm itself, external loadings on the arm, and vibration, among other things.

Thus, there is a need for an improved barrier that is simple to operate and less vulnerable to failure.

### BRIEF SUMMARY OF THE INVENTION

The above-listed needs are met or exceeded by the present crossing arm for a vehicle including a plurality of hollow telescoping members. The telescoping members are mounted onto the vehicle and configured for extension with respect to a surface of the vehicle. The members define a variable volume chamber, where the chamber has a minimum volume when the members are nested, and the chamber has a maximum volume when the members are extended. An actuator is in fluid communication with the plurality of telescoping members and is configured for delivering fluid to the chamber to move at least one telescoping member with respect to a second telescoping member to extend the crossing arm.

A crossing arm having a telescoping axis that is parallel to a longitudinal axis of a vehicle includes a centermost telescoping member centered about the telescoping axis, and at least one generally hollow second telescoping member that is concentrically disposed about the telescoping axis. One of the second telescoping members is configured to permit the reciprocable telescoping motion of the centermost telescoping member with respect to the second telescoping member. A generally hollow outermost telescoping member is concentrically disposed about the second telescoping member. The centermost telescoping member, the second telescoping member and the outermost telescoping member are in sealed fluid communication with an actuator configured for delivering fluid. The centermost telescoping member is extensible and retractable when the actuator is actuated.

An alternate embodiment of crossing arm for a vehicle includes a plurality of hollow telescoping members. The telescoping members are mounted onto a side surface of the vehicle and configured for extension generally parallel to the longitudinal axis of the vehicle and from the side surface of the vehicle. The members are sealingly and slidingly attached to each other to define a variable volume chamber, where the chamber has a minimum volume when the members are nested, and the chamber has a maximum volume when the members are extended. An actuator is in fluid communication with the plurality of telescoping members and is configured for delivering fluid to the chamber to move at least one telescoping member with respect to a second telescoping member to extend the crossing arm. A fluid tank is mounted on the vehicle and in fluid communication with the actuator for delivering fluid to the actuator.

### BRIEF DESCRIPTION OF THE DRAWINGS

FIG. 1A is a side plan view of a front portion of a bus having the present bus crossing arm in the retracted position;

FIG. 1B is a side plan view of the front portion of the bus having the present bus crossing arm in the extended position;

FIG. 2 is a schematic section view of the bus crossing arm and a pneumatic actuator; and

FIG. 3 is a perspective view of a bus crossing arm having a guard.

### DETAILED DESCRIPTION OF THE INVENTION

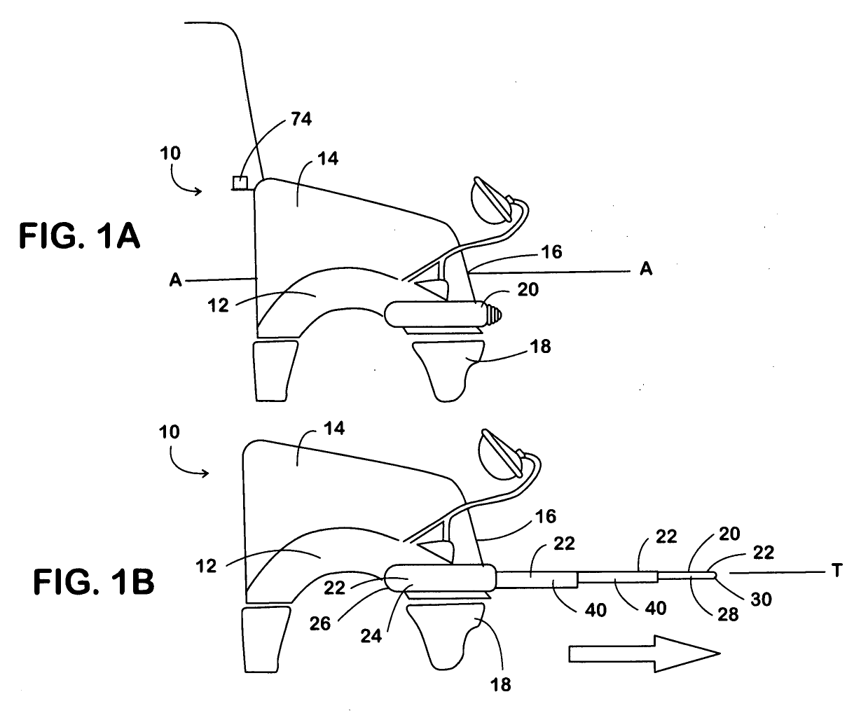

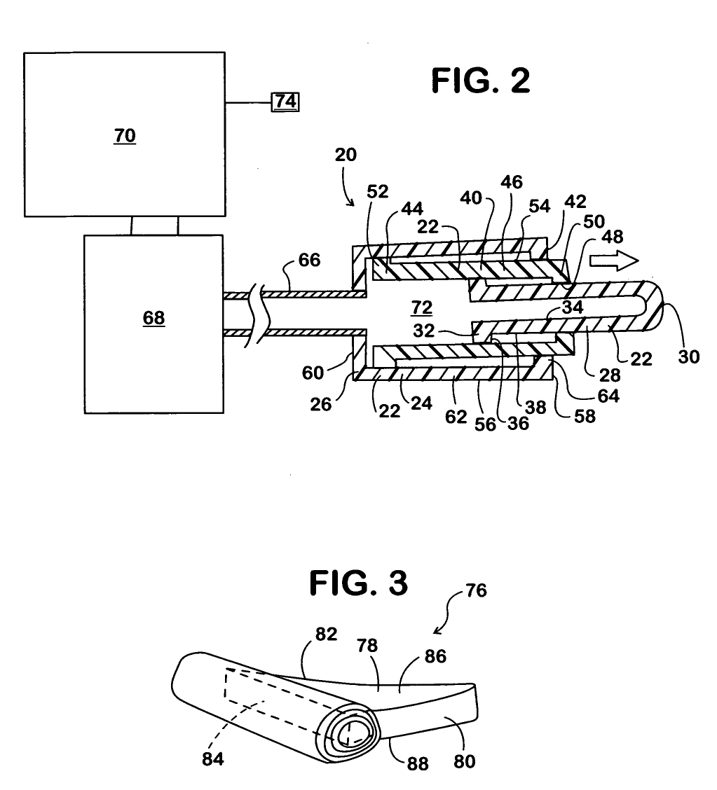

Referring to FIGS. 1A-2, a front portion of a bus is indicated generally at 10, and includes a wheel well cover 12 disposed at an exterior side surface 14 of the bus. Curving around from a front surface 16 to the side surface 14 of the bus is a bumper 18. The bus 10 also includes a crossing arm 20 attached to the side surface 14 preferably adjacent the bumper 18. Since the crossing arm 20 is preferably externally mounted to the side surface 14, it is more easily integrated on an existing bus 10. While the following description is made with respect to a bus 10, it is contemplated that the crossing arm 20 can be incorporated on any vehicle.

The crossing arm 20 is employed for the purpose of preventing people from passing too closely to the front of the bus 10 so that they can be observed crossing the path of the bus by the driver. The crossing arm 20 is telescopically moveable from a retracted position (FIG. 1A) to an extended position (FIG. 1B). In the extended position, the crossing arm 20 extends generally parallel to the longitudinal axis “A” of the bus, and generally perpendicular to the bumper 18.

In the preferred embodiment of crossing arm 20, the crossing arm includes a plurality of telescoping members 22 that are generally cylindrical and hollow. The telescoping members 22 concentrically nest with each other about a telescoping axis “T” that is generally parallel to the longitudinal axis “A”, while in the retracted position. In the extended position, each of the telescoping members 22, except for an outermost member 24, extends from a proximal end 26 of the crossing arm 20 along the telescoping axis “T” to be generally horizontal with respect to the ground.

A centermost telescoping member 28 has an enclosed distal end 30, a proximal end 32, and a body 34 extending between the ends. The distal end 30 is preferably rounded to eliminate sharp corners. A generally annular lip 36 is disposed on an exterior surface 38 of the body 34 at the proximal end 32.

Adjacent to and concentric with the centermost telescoping member 28 is the second telescoping member 40. The second telescoping member 40 is generally similar to the centermost telescoping member 28 in that it has a distal end 42, a proximal end 44, and a body 46 extending between the ends. However, the distal end 42 of the second telescoping member 40 has an opening 48 defined by a generally annular shoulder 50. The opening 48 permits the centermost telescoping member 28 to protrude out from the distal end 42, and to slide relative to the second telescoping member 40.

A generally annular lip 52 is disposed on an exterior surface 54 of the second telescoping member 40. The second telescoping member 40 is slidable within an adjacent telescoping member 22.

In FIG. 2, three telescoping members 22 are shown, however it should be understood that any number of telescoping members can be incorporated. In the embodiment with three telescoping members 22, the second telescoping member 40 of is moveable within the outermost member 24.

The outermost member 24 forms an outer housing 56 of the crossing arm 20. The outermost member 24 is generally cylindrical, having a distal end 58, a proximal end 60, and a body 62 extending between the ends. At the distal end 58, the outermost member 24 has a generally shoulder 64, similar to the shoulder 50 on the second telescoping member 40. The proximal end 60 is sealingly engaged with a hose 66.

The crossing arm 20 is actuated by an actuator 68, as known in the art and commercially available. The actuator 68 is supplied with fluid, typically air, from an air tank 70 mounted on the bus 10, however it is contemplated that the actuator can use any type of fluid (i.e. liquid or gas). The actuator 68 pushes the fluid through the hose 66, which is connected to a chamber 70 formed within the crossing arm 20.

The telescoping members 22 define the generally fluid-tight chamber 72 having a variable volume. When fluid is pushed into the crossing arm 20, the telescoping members 22 are preferably deployed in sequence with the centermost telescoping member 28 extending outward (in the direction of the arrow) first, then the second telescoping member 40, in sequence until all members are fully telescoped. With the telescoping members 22 extended, the chamber 72 has increased volume as compared to the retracted position.

The driver preferably initiates the actuator 68 with an input device 74 located in the cab of the bus 10. It is contemplated that the actuator 68 can be configured to actuate only when the bus 10 is stopped. The actuator 68 is preferably configured to regulate the force with which the telescoping members 22 are pneumatically deployed outward. Further, the length of extension of the crossing arm 20 can be determined for each individual bus 10, or can be based on regulations for bus operation.

The shoulders 50, 64 on the larger diameter telescoping members 22 allow each smaller telescoping member 22 to engage the shoulder with the smaller member's lip 36, 52, thereby preventing the smaller member from disengaging from the crossing arm 20. It is contemplated that other mechanical stops can be used instead of a lip/shoulder engagement.

When the telescoping members 22 are retracted, the actuator 68 will draw out the fluid from the chamber 72 and put it back in the tank 70. This creates a vacuum in the chamber 72, and each telescoping member 22 will withdraw into the nested position to create a smaller chamber volume.

The telescoping members 22 are preferably plastic, and more preferably high impact plastic. However, any rigid lightweight material can be used.

Preferably, the crossing arm 20 is near perfectly horizontal in the extended position when mounted on the side surface 14 of the vehicle 10 horizontally. In other words, the telescoping members 22 preferably do not sag when they are extended. It is preferable for the crossing arm 20 to be straight and rigid on windy days when the arm is likely to be buffeted about by cross winds.

It is contemplated that additional lips or other mechanical structures can be added along the length of the telescoping members 22 to keep the crossing arm 20 generally aligned with the telescoping axis “T”. For example, an additional shoulder/lip at the distal end of each telescoping member 22 (with the exception of the centermost member 28) will counteract the bending moments of the telescoping members 22 distal from it. The shoulder/lip at the distal end of the outer member 22 would interface with the shoulder/lip of the proximal inner tube, thus preventing the segments from shooting out of the crossing arm, and also reinforcing the chamber seal. Alternately, the lip can be thicker along the length of the telescoping member 22. Further, the amount of fluid deployed into the chamber could also act to keep the deployed arm generally straight.

Referring now to FIG. 3, a guard structure 76 is attached to or integrally formed with the crossing arm 20, and specifically, the outermost member 24. The guard structure 76 is configured to prevent objects from snagging on the crossing arm 20 or getting caught between the crossing arm and the bus 10.

The guard structure 76 includes a generally “wedge”-shaped body 78 that extends from the crossing arm 20 to the side surface 14 of the bus 10. The body 78 includes a front surface 80, a back surface 82 configured for attachment to the vehicle 10, a side surface 84 attached to the crossing arm 20, an upper surface 86 and a lower surface 88. The front surface 80, the upper surface 86 and the lower surface 88 are preferably smooth.

While particular embodiments of the present crossing arm have been shown and described, it will be appreciated by those skilled in the art that changes and modifications may be made thereto without departing from the invention in its broader aspects and as set forth in the following claims.

1. A crossing arm for a vehicle, comprising:
a plurality of hollow telescoping members mounted onto the vehicle and configured for extension from a surface of the vehicle, said members defining a variable volume chamber, wherein said chamber has a minimum volume when said members are nested, and said chamber has a maximum volume when said members are extended; and
an actuator in fluid communication with said plurality of hollow telescoping members and configured for delivering fluid to said chamber to extend at least one telescoping member with respect to a second telescoping member.

2. The crossing arm of claim 1 wherein said actuator is also configured for drawing fluid from said chamber to retract said at least one telescoping member with respect to said second telescoping member.

3. The crossing arm of claim 1 wherein said actuator is in fluid connection with an air tank of the vehicle.

4. The crossing arm of claim 1 wherein said plurality of telescoping members comprises a centermost telescoping member having an enclosed distal end, a proximal end, and a body extending between the ends.

5. The crossing arm of claim 4 wherein the distal end is rounded.

6. The crossing arm of claim 4 further comprising a lip disposed on an exterior surface of said body at said proximal end.

7. The crossing arm of claim 6 further comprising a second telescoping member having a distal end, a proximal end, and a body extending between the ends, wherein said distal end of said second telescoping member has an opening defined by a shoulder, and said opening permits the telescoping motion of said centermost telescoping member relative to said second telescoping member.

8. The crossing arm of claim 6 wherein said lip and said shoulder are configured for limiting the outward extension of said telescoping members.

9. The crossing arm of claim 1 wherein said plurality of telescoping members are generally cylindrical.

10. The crossing arm of claim 1 wherein said at least one telescoping member is extended automatically with an input device.

11. A crossing arm having a telescoping axis that is parallel to a longitudinal axis of a vehicle, comprising:
a centermost telescoping member centered about the telescoping axis;
at least one generally hollow second telescoping member that is concentrically disposed about the telescoping axis, wherein one of said second telescoping members is configured to permit the reciprocable telescoping motion of said centermost telescoping member with respect to said second telescoping member; and
a generally hollow outermost telescoping member that is concentrically disposed about said at least one second telescoping member, wherein said centermost telescoping member, said at least one second telescoping member and said outermost telescoping member are in sealed fluid communication with an actuator configured for delivering fluid to said telescoping members;
wherein said centermost telescoping member is extensible and retractable when said actuator is actuated.

12. The crossing arm of claim 11 wherein said centermost telescoping member, said at least one second telescoping member and said outermost telescoping member define a variable volume chamber, wherein said chamber has a minimum volume when said members are retracted, and said chamber has a maximum volume when said members are extended.

13. The crossing arm of claim 11 wherein said centermost telescoping member is hollow.

14. The crossing arm of claim 11 wherein said centermost telescoping member is rounded.

15. The crossing arm of claim 11 wherein said centermost telescoping member includes a lip on an exterior surface, and said at least one second telescoping member includes a shoulder on an interior surface, wherein said lip engages said shoulder to limit the outward extension of the centermost telescoping member.

16. A crossing arm for a vehicle having a longitudinal axis, comprising:
a plurality of hollow telescoping members mounted onto a side surface of the vehicle and configured for extension generally parallel to the longitudinal axis from said side surface of the vehicle, said members sealingly and slidingly attached to each other and defining a variable volume chamber, wherein said chamber has a minimum volume when said members are nested, and said chamber has a maximum volume when said members are extended; and
an actuator in fluid communication with said plurality of hollow telescoping members and configured for delivering fluid to said chamber to extend at least one telescoping member with respect to a second telescoping member;
a fluid tank mounted on the vehicle and in fluid communication with said actuator for delivering fluid to said actuator.

17. The crossing arm of claim 16 wherein said actuator is pneumatic.

18. The crossing arm of claim 16 wherein said actuator is hydraulic.

19. The crossing arm of claim 16 further comprising a hose connecting said actuator to said plurality of telescoping members.

20. The crossing arm of claim 16 wherein said actuator is configured to withdraw fluid from said plurality of telescoping members to retract said members to nest.
